(19) United States
(12) Patent Application Publication
(10) Pub. No.: US 2014/0000075 A1
(43) Pub. Date: Jan. 2, 2014

(54) Casket Decorative Covering

(71) Applicant: Rodney Catlett, Stafford, VA (US)

(72) Inventor: Rodney Catlett, Stafford, VA (US)

(21) Appl. No.: 13/539,865

(22) Filed: Jul. 2, 2012

(51) Int. Cl. A61G 17/00

(52) U.S. Cl. 27/14

(57) ABSTRACT

A casket with decorative covering comprising a casket, where the casket includes a pair of elongated side walls, a pair of short side walls, a base and a segmented lid; a casket cover, where the casket cover is affixed to the pair elongated side walls and the segmented lid, and where the casket cover is made from a durable, waterproof material; and a plurality of graphics atop the casket cover, where the plurality of graphics are positioned along the elongated side walls and the segmented lid to created a personalized and customized look to the casket.

### BACKGROUND OF THE INVENTION

1. Field of the Invention

The present invention relates to a casket cover that allows a user to personalize and customize the look of a casket.

2. Description of Related Art

Caskets or coffins or urns are common items associated with death and funerals. These items are used to house the body of a deceased individual before they are placed in their final resting place. Although the sight of a casket or urn is bothersome of many individuals, it is still a topic of necessary discussion upon the death or leading to the death of a loved one. Many times, caskets and urns are covered with a darkened finish with metallic edges or embellishments. Still, some individuals opt for a wood casket without decorative edges or handles. Adding to the costs of the caskets, personalization like pictures, carvings or metal working may be added to the casket, but this may lead to the costs skyrocketing depending on the detail and amount of customization desired.

It would be desirable in the art to provide a casket that allows for decoration without the astronomical costs associated. It would also be beneficial in the art for the decoration to be customizable to reflect the personal interests of the deceased loved one.

### SUMMARY OF THE INVENTION

In view of the foregoing disadvantages in the prior art, the purpose of the present invention is to provide a customizable casket cover.

Accordingly, an object of the present invention is to provide a covering for a casket wherein the covering provides customizable graphics that surround the casket to reflect the interest of the deceased loved one.

To achieve the above objects, in an aspect of the present invention, a casket with decorative covering is described comprising a casket, where the casket includes a pair of elongated side walls, a pair of short side walls, a base and a segmented lid; a casket cover, where the casket cover is affixed to the pair elongated side walls and the segmented lid, and where the casket cover is made from a durable, waterproof material; and a plurality of graphics atop the casket cover, where the plurality of graphics are positioned along the elongated side walls and the segmented lid to created a personalized and customized look to the casket.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a casket with decorative covering in a closed position in accordance with an exemplary embodiment of the present invention; and

FIG. 2 depicts a perspective view of a casket with decorative covering in an open position in accordance with an exemplary embodiment of the present invention.

Like reference numerals refer to like parts throughout the description of several views of the drawings.

### DETAILED DESCRIPTION OF THE DRAWINGS

The present invention relates to a casket cover that allows a user to personalize and customize the look of a casket. The decorative casket cover is made from a waterproof durable material that is quickly and easily affixes to any size casket or urn. Loved ones are able to select and choose which logos, designs, pictures or even sayings they wish to emblazon onto the casket with decorative covering which may express the personality and interest of loved family members and friends.

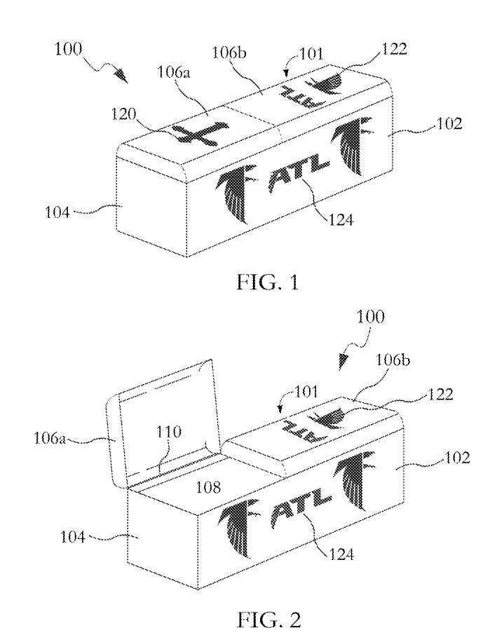

Turning now descriptively to the drawings, referring to FIG. 1, a perspective view of a casket with decorative covering 100 is shown in a closed position in accordance with an exemplary embodiment of the present invention. The casket with decorative covering 100 envelops a casket 101, where the casket 101 includes a pair of elongated side walls 102 and a pair of short side walls 104. The casket 101 further includes a base (not shown) and a segmented lid 106a, 106b. FIG. 1 illustrates the lid 106a, 106b in a closed position, but as illustrated in FIG. 2 a portion 106a, or the entire lid 106a, 106b may be lifted to allow access into the inner cavity 108 of the casket 101. The casket 101 may be made from wood, aluminum, steel, or fiberglass.

The casket with decorative covering 100 may be a cover that attaches to all of the outer surfaces of the casket 101, or may simply cover the elongated sides 102 and the lid 106a, 106b. Atop the casket with decorative covering 100 may be a plurality of graphics 120, 122, 124. The graphics 120, 122, and 124 may be logos, pictures, quotes or sayings, drawings, cartoons, symbols, membership graphics and the like to reflect the interest of the deceased loved one. The graphics 120, 122, 124 are customizable to allow a user to pick what they what to be illustrated and where. For example, graphic 120 is a cross to reflect a religious background, graphic 122 is an Atlanta Falcon graphic for a lid and graphic 124 is the Atlanta Falcon for the side to reflect a particular fondness for a sport or sports team. The casket with decorative covering 100 is made from a durable, waterproof material like Gore-tex® or plastic.

Referring now to FIG. 2, a perspective view of the casket with decorative covering 100 is shown with the casket 101 in an open position in accordance with an exemplary embodiment of the present invention. A portion of the lid 106a may be opened as illustrated in FIG. 2, to allow access into the inner cavity 108. The lid 106a opens on a hinge 110. To allow easy opening of the lid 106a, 106b the graphics 120, 122 and 124 are separate from each other.

The casket with decorative covering 100 may be applied to the casket 101 using heat application or adhesive. Alternatively the casket with decorative covering 100 may be removable by utilizing hook and loop fasteners (commonly referred to as Velcro®) to removably attach the graphics 120, 122, 124. Due to each individual's particular interests and hobbies each casket with decorative covering 100 is unique and special allowing loved ones to celebrate a person's life rather than mourn their death.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. (canceled)

2. (canceled)

3. (canceled)

4. (canceled)

5. (canceled)

6. (canceled)

7. (canceled)

8. (canceled)

9. A decorative covering for a casket comprising:
a casket cover, where the casket cover is removably affixed to an outer surface of a casket with hook and loop fasteners, where the casket includes a segmented lid, a pair elongated side walls and a pair of short sided walls and the segmented lid, and where the casket cover includes a lid section, elongated side wall sections and short sided sections; and
a plurality of graphics over the surface of the casket cover, where the plurality of graphics are positioned along the lid section, the elongated side wall sections shorted sided sections of the casket cover to create a personalized and customized look to the casket.

10. The decorative covering according to claim 9, wherein the plurality of graphics are one of at least a logo, a drawing, a picture, a carton, a symbol, a membership graphic, a quote and saying.

11. The decorative covering according to claim 9, wherein the casket cover is made from a durable waterproof material.

12. The decorative covering according to claim 11, where the durable, waterproof material is Gore-tex®. is made from a durable, waterproof material.

13. The decorative covering according to claim 11, wherein the durable waterproof material is plastic.

14. The decorative covering according to claim 9, wherein the casket cover is applied to the casket with one of at least heat application and adhesive.

15. (canceled)

16. (canceled)
